(19) United States
(12) Patent Application Publication
(10) Pub. No.: US 2013/0150759 A1
(43) Pub. Date: Jun. 13, 2013

(54) AUTOMATIC CHEST COMPRESSION DEVICE

(71) Applicant: Kazufuku Nitta, Saitama (JP)

(72) Inventor: Kazufuku Nitta, Saitama (JP)

(21) Appl. No.: 13/702,116

(22) PCT Filed: Jun. 10, 2011
(86) PCT No.: PCT/JP2011/063388

§ 371 Date: Dec. 5, 2012

(30) Foreign Application Priority Data
Jun. 10, 2010 (JP) 2010-133248

(51) Int. Cl. A61H 31/00

(52) U.S. Cl. CPC A61H 31/00
USPC 601/41

(57) ABSTRACT

An automatic chest compression device includes: a pressure member that makes abutting contact with the chest of a body; a driving unit that makes the pressure member move to and fro; a pressure receiving unit that allows rescuer's hands to receive a reaction force which is generated on the side of the driving unit when the chest of the body is compressed by the pressure member; and a control unit that calculates a substantial amount of depression of the chest by the pressure member, and controls a stroke of the pressure member given by the driving unit. As a result, chest compression can be applied reliably while any complicate operation is not required.

### TECHNICAL FIELD

The present invention relates to an automatic chest compression device used for cardiac massage applied in response to arrest of respiration or pulsation, and relates to a device suitably applied for cardiopulmonary resuscitation of infants and children, for example.

### BACKGROUND ART

In response to sudden arrest of a heart or respiration, sternum compression (cardiac massage) is applied to forcedly assist the respiration and the circulation of a body. Operation of this sternum compression is as follows. First, with both hands overlapping each other, a rescuer places the roots of the hands on a line connecting the nipples of a patient.

Then, the rescuer applies a force to depress the sternum of the patient about 4 to 5 cm into the body. At this time, the rescuer straightens elbows to apply a force appropriately to the patient and to avoid physical exhaustion of the rescuer. This operation is repeated at a speed of about 100 times per minute. For example, the rescuer compresses the chest 30 times, gives artificial respiration quickly twice, and then compresses the chest again 30 times. The rescuer continues this cycle to apply external pressure forcedly to the heart inside the sternum.

A human brain is brought into a hypoxic condition after elapse of from four to six minutes after respiratory arrest to become difficult to recover. For example, it is said that a life is saved with probability of about 90 percent if cardiopulmonary resuscitation is started within 2 minutes after cardiac arrest. However, it is also said that this probability becomes about 50 and 25 percent if cardiopulmonary resuscitation is started after elapse of four minutes and five minutes respectively after cardiac arrest. Thus, a life is saved with probability that depends, to a large degree, on how early cardiopulmonary resuscitation is given after cardiac arrest. The aforementioned chest compression should never be given up or suspended if there is no other means for resuscitation.

Meanwhile, the aforementioned chest compression necessitates a great deal of power of a rescuer, thereby placing a heavy physical burden on the rescuer. In particular, if the rescuer is a woman or an elderly person, for example, sufficient compression may not be applied.

Thus, as described in Japanese Patent Application Laid-Open No. 2002-272801, a conventionally suggested automatic chest compression device has a structure where a pressure member is housed in a case with grips so as to be movable vertically, and the pressure member is caused to move vertically by an electromagnetic coil (see patent literature 1, for example). A rescuer applies this automatic chest compression device to a patient's chest while holding the device firmly with hands. If an automatic cardiopulmonary resuscitator is operated in this condition, the pressure member moves vertically to automatically compress the chest.

### SUMMARY OF INVENTION

### Technical Problem

The conventional automatic chest compression device has a problem in that the rescuer cannot understand well how deeply a patient's sternum is actually depressed. In particular, if the rescuer has no experience in cardiopulmonary resuscitation, the rescuer cannot initially determine to which degree a sternum should be compressed. Trying to depress a sternum 4 to 5 cm as described above may break a rib in some cases. Resuscitation is given higher priority than bone fracture on site, so that fracture of the rib is ignorable. However, the unexperienced person feels intimidated in depressing a sternum to a degree that leads to fracture of a rib. Thus, even with the use of this automatic chest compression device, the unexperienced person weakens a force applied through the grips.

Meanwhile, a rescuer may apply a force more than necessary to depress a sternum with the force of the rescuer himself or herself. In this case, the automatic cardiopulmonary resuscitator is depressed further, leading to excessive compression.

In some cases, cardiopulmonary resuscitation should be given to infants and children including immature babies. For example, the cardiopulmonary function of a baby born premature has not been developed sufficiently, so that cardiac arrest is likely to occur. In this case, chest compression should be applied simultaneously with the birth. Meanwhile, in the case of an immature baby, the thickness of a chest is about some centimeters in the first place, and bones are fragile. Thus, a rescuer has no way of determining to which depth a chest should be compressed. This also becomes a problem relating to chest compression to be applied to animals of various body sizes in animal hospitals, for example.

The invention has been made in consideration of the aforementioned problems. It is an object of the invention to provide an automatic chest compression device that applies chest compression appropriately depending on the situation.

### Solution to Problem

The aforementioned object is achieved by the following means devised as a result of earnest study by the inventors.

Specifically, the present invention to achieve the aforementioned object is directed to an automatic chest compression device, including: a pressure member that makes abutting contact with a chest of a body; a driving unit that makes the pressure member move to and fro; a pressure receiving unit that allows rescuer's hands to receive a reaction force which is generated on the side of the driving unit when the chest of the body is compressed by the pressure member; and a control unit that calculates a substantial amount of depression of the chest by the pressure member, and controls a stroke of the pressure member given by the driving unit.

Further, in the aforementioned automatic chest compression device, it is preferable that the pressure receiving unit include a restraining unit provided to fix fingers of hands of a rescuer.

Further, in the aforementioned automatic chest compression device, it is preferable that the restricting unit fix thumbs of the hands.

It is preferable that the aforementioned automatic chest compression device further include a pressurizing-side moving sensor arranged on the side of the pressure member, the pressurizing-side moving sensor measuring a condition of movement of the pressure member.

It is preferable that the aforementioned automatic chest compression device further include a pressure receiving-side moving sensor arranged on the side of the pressure receiving unit, the pressure receiving-side moving sensor measuring a condition of movement of the pressure receiving unit.

It is preferable that the aforementioned automatic chest compression device further include a stroke determining unit that determines a relative stroke between the pressure member and the driving unit.

Further, in the aforementioned automatic chest compression device, it is preferable that the control unit increase the relative stroke of the pressure member given by the driving unit if the substantial amount of depression by the pressure member falls below a lower threshold.

Further, in the aforementioned automatic chest compression device, it is preferable that the control unit reduce the relative stroke of the pressure member given by the driving unit if the substantial amount of depression by the pressure member exceeds an upper threshold.

Further, in the aforementioned automatic chest compression device, it is preferable that the control unit include a notifying unit that informs the rescuer of shortage or excess of holding power.

Further, in the aforementioned automatic chest compression device, it is preferable that the notifying unit notify the rescuer of shortage of the holding power if the substantial amount of depression by the pressure member is insufficient.

Further, in the aforementioned automatic chest compression device, it is preferable that the notifying unit notify the rescuer of excess of the holding power if the substantial amount of depression by the pressure member is excessive.

Further, in the aforementioned automatic chest compression device, it is preferable that the notifying unit notify the rescuer of shortage of the holding power if the relative stroke between the pressure member and the driving unit is greater than an upper threshold of the stroke.

Further, in the aforementioned automatic chest compression device, it is preferable that the notifying unit notify the rescuer of excess of the holding power if the relative stroke between the pressure member and the driving unit is smaller than a lower threshold of the stroke.

Further, in the aforementioned automatic chest compression device, it is preferable that the control unit include a depression amount setting unit that sets a target value of the substantial amount of depression by the pressure member.

Further, in the aforementioned automatic chest compression device, it is preferable that the control unit include an operation starting and stopping controller that controls start and stop of depressing operation by the pressure member on the basis of whether an external force is applied to the pressure member or not.

### Advantageous Effects of Invention

The present invention can achieve excellent effect of giving chest compression reliably without involving any complicate operation.

### BRIEF DESCRIPTION OF DRAWINGS

FIGS. 1(A) and 1(B) are a cross-sectional view and a top view, respectively, showing the entire structure of an automatic chest compression device according to an embodiment of the present invention.

FIG. 2 is a block diagram showing the functional structure of a program executed by a control unit of the automatic chest compression device.

FIG. 3 is a diagram showing exemplary use of the automatic chest compression device.

FIG. 4 is a diagram showing exemplary use of the automatic chest compression device.

### DESCRIPTION OF EMBODIMENTS

An example of an embodiment of the present invention will be described in detail below by referring to the drawings.

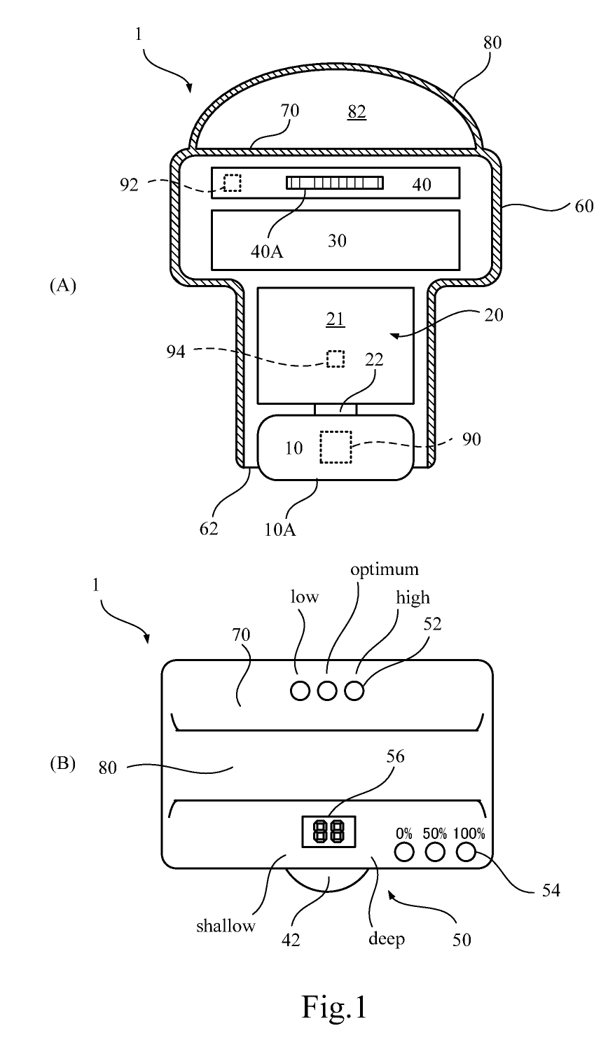

FIG. 1 shows the entire structure of an automatic chest compression device 1 according to the present embodiment. The automatic chest compression device 1 includes a pressure member 10 that makes abutting contact with the chest of a body, a driving unit 20 that makes the pressure member 10 move to and fro, a rechargeable battery 30 that supplies the driving unit 20 with electricity, a control unit 40 that controls the operation of the driving unit 20, a notifying unit 50 that transmits various information to a rescuer, a housing 60 that houses these components, and a pressure receiving unit 70 formed in the housing 60.

The pressure member 10 has a pressure surface 10A formed in a flat condition while directed downward. The pressure surface 10A is pressed against the chest of a body to depress the chest. At least the pressure surface 10A is covered with an elastomer such as natural rubber and synthetic rubber, so that the pressure surface 10A does not damage patient's skin during pressure application.

The driving unit 20 is what is called an electromagnetic solenoid, and includes an AC or DC magnetizing coil 21 on the stationary side, and a movable core 22 on the movable side. Energizing the magnetizing coil 21 causes the movable core 21 to move, thereby converting electromagnetic energy to mechanical translatory movement. Controlling a current to be applied to the magnetizing coil allows continuous control of the displacement of the movable core 22. The pressure member 10 is fixed to a tip end of the movable core 22. Thus, the driving unit 20 makes the pressure member 10 move linearly to and fro. Instead of the electromagnetic solenoid described here, other techniques are applicable including technique of converting the rotation of a motor to linear movement by using a cam mechanism, for example. Driving sources such as air and hydraulic pressure are applicable instead of electricity.

The driving unit 20 further includes a stroke sensor 94 that detects an actual amount of movement (amount of stroke) of the movable core 22. The stroke sensor 94 is what is called a linear gauge, and is capable of outputting a relative stroke (amount of relative movement) between the magnetizing coil 21 and the movable core 22 as an electrical signal. This relative stroke agrees with the amount of the relative movement between the driving unit 20 and the pressure member 10.

Here, the rechargeable battery 30 is a lithium-ion battery, and is capable of storing sufficient electricity required for chest compression operation by the driving unit 20.

The control unit 40 is what is called a control substrate, and includes a power supply circuit, a memory, an information processing device (processor), a current control circuit, a volume circuit, a display control circuit, and the like. The control unit 40 controls the relative stroke of the driving unit 20. The control unit 40 also controls the notifying unit 50 to transmit appropriate information to a rescuer. The control unit 40 includes a stroke adjuster 40A of a volume structure. A target amount of depression can be adjusted in response to rotation of the stroke adjuster 40A by a rescuer. Various sensors are installed on the automatic chest compression device 1 in order to achieve the target amount of depression. While calculating a substantial amount of depression by the pressure member 10, the control unit 40 exerts control to feed back a result of the calculation.

The notifying unit 50 includes a holding power notifying part 52 that informs a rescuer of shortage or excess of the holding power, a remaining battery level notifying part 54 that notifies the rescuer of the remaining charged power of the rechargeable battery 30, and a depression amount notifying part 56 that presents the target amount of depression, an actual amount of depression, and the like to the rescuer. Operations of these parts are described in detail later.

The housing 60 is a cover that houses the pressure member 10, the driving unit 20, the rechargeable battery 30, the control unit 40, the notifying unit 50, and the like. In particular, the housing 60 holds the magnetizing coil 21 to become the fixed side of the driving unit 20. Further, an opening 62 is formed at or near the lower part of the housing 60, and part of the pressure member 10 projects downward through the opening 62. The driving unit 20 is configured to eject the pressure member 10 further downward through the opening 62.

The pressure receiving unit 70 of the present embodiment is constituted by using the upper surface of the housing 60. When the chest of a body is compressed by the pressure member 10, a reaction force comparable to the depressing force is generated on the side of the driving unit 20. The pressure receiving unit 70 is used when the reaction force is received by rescuer's hands. The pressure receiving unit 70 of the present embodiment is configured to make abutting contact with the surfaces on the side of fingerprints of the thumbs of hands, so that the reaction force is received by the thumbs. As a result, while holding the body for example of an immature baby with both hands, a rescuer is capable of maintaining an appropriate holding power with both thumbs.

The pressure receiving unit 70 is provided with a restraining unit 80 for fixation of rescuer's hands. The restraining unit 80 is a strip-shaped band to make abutting contact with the surfaces on the side of nails of the thumbs of the hands. An insertion space 82 allowing insertion of hands or fingers is formed between the restraining unit 80 and the pressure receiving unit 70. Thus, inserting thumbs into the insertion space 82 allows the automatic chest compression device 1 to be held stably with the thumbs, thereby preventing separation of the automatic chest compression device 1 from fingers.

The automatic chest compression device 1 further includes a pressurizing-side moving sensor 90 provided on the side of the pressure member 10. The “pressurizing side” mentioned here includes all areas moving integrally with the pressure member 10, and these areas include the movable core 22 of the driving unit 20, for example. The pressurizing-side moving sensor 90 is what is called an acceleration sensor, and detects the amount and the speed of movement of the pressure member 10.

The automatic chest compression device 1 further includes a pressure receiving-side moving sensor 92 provided on the side of the pressure receiving unit 70. The “pressure receiving side” mentioned here includes all areas moving integrally with the pressure receiving unit 70, and these areas include the housing 60, the control unit 40, and the magnetizing coil 21 of the driving unit 20, for example. In the present embodiment, the pressure receiving-side moving sensor 92 is installed on the control unit 40. The pressure receiving-side moving sensor 92 is what is called an acceleration sensor, and detects the amount and the speed of movement of the pressure receiving unit 70.

The structure for control of the control unit 40 will now be described.

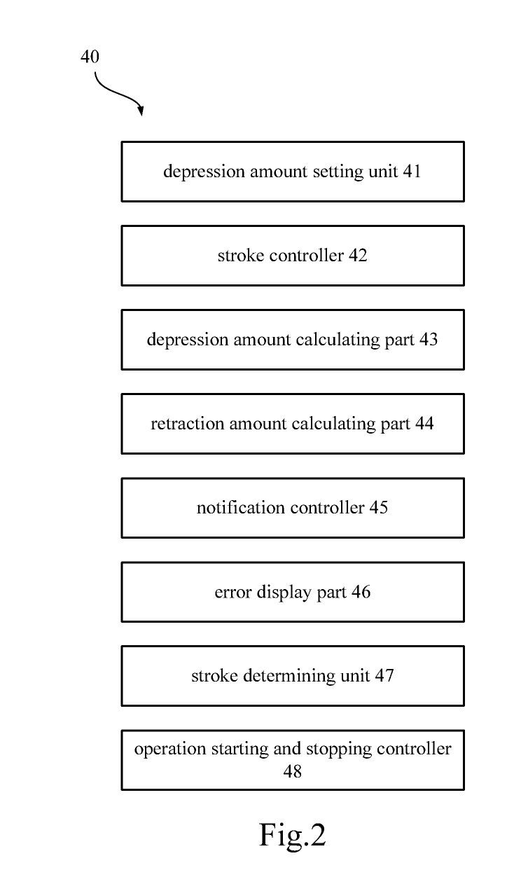

FIG. 2 shows the functional structure of a program executed by the information processing device of the control unit 40. The control unit 40 includes a depression amount setting unit 41, a stroke controller 42, a depression amount calculating part 43, a retraction amount calculating part 44, a notification controller 45, an error display part 46, a stroke determining unit 47, and an operation starting and stopping controller 48. The depression amount setting unit 41 sets a target value of a substantial amount of depression of a patient's chest by the pressure member 10. A rescuer can freely change this target value to be set by rotating the stroke adjuster 40A. A result of the setting is digitally displayed on the stroke notifying part 56 through the notification controller 45.

Based on the result of detection obtained by the pressurizing-side moving sensor 90, the depression amount calculating part 43 calculates a substantial amount of depression by the pressure member 10. The “substantial amount of depression” mentioned here means the amount of depression of a patient's chest, specifically, the amount of absolute movement of the pressure member 10.

Based on the result of the calculation obtained by the depression amount calculating part 43, the stroke controller 42 controls the driving unit 20. More specifically, if the substantial amount of depression falls below a lower threshold (here, the target amount of depression is used as it is), the amount of the relative stroke between the driving unit 20 and the pressure member 10 is increased. Meanwhile, if the substantial amount of depression exceeds an upper threshold (here, the target amount of depression is used as it is), the amount of the relative stroke between the driving unit 20 and the pressure member 10 is reduced. In this way, the stroke controller 42 always exerts feedback control such that the substantial amount of depression agrees, to the maximum possible extent, with the target amount of depression. Here, the target amount of depression is used as it is as both the lower and upper thresholds, to which the invention is not intended to be limited. For example, it is preferable that a value smaller by a certain amount than the target amount of depression be used as the lower threshold, and that a value greater by a certain amount than the target amount of depression be used as the upper threshold. Providing certain ranges (biases) to the upper and lower limits in this way allows suppression of chattering to occur during control of the relative stroke. It is also preferable that the notification controller 45 digitally display the substantial amount of depression calculated by the depression amount calculating part 43 on the stroke notifying part 56 during operation, as this allows a rescuer to always check a current condition of chest compression. The stroke controller 42 controls the speed of relative stroke such that the driving unit 20 gives a relative stroke at a speed of about 100 times per minute.

Based on the result of detection obtained by the pressure receiving-side moving sensor 92, the retraction amount calculating part 44 calculates a substantial amount of retraction of the pressure receiving unit 70. When the automatic chest compression device 1 is applied to a patient's chest and operated, the pressure member 10 depresses a sternum. Then, a reaction force comparable to the pressing force is generated. This reaction force is transmitted through the pressure receiving unit 70 to rescuer's hands. If the pressure receiving unit 70 is held by the rescuer's hands with low holding power, the pressure receiving unit 70 retracts upward, leading to shortage of the substantial amount of depression by the pressure receiving member 10. Thus, the retraction amount calculating part 44 calculates the substantial amount of retraction of the pressure receiving unit 70 to determine whether the holding power with hands is short or not. For example, if the substantial amount of retraction is greater than an upper threshold of the amount of retraction, the retraction amount calculating part 44 determines that the holding power is short. In this case, the notification controller 45 makes an indicator “low” at the holding power notifying part 52 light up to urge a rescuer to increase the holding power. Conversely, if the substantial amount of retraction is smaller than a lower threshold of the amount of retraction, the retraction amount calculating part 44 determines that excessive holding power is applied. In this case, the notification controller 45 makes an indicator “high” at the holding power notifying part 52 light up to urge the rescuer to reduce the holding power. The application of excessive holding power generally means the case when a patient's sternum is depressed excessively with the power of hands. Thus, it is preferable that the lower threshold be a negative value with respect to the direction of retraction (upward direction).

Further, in the present embodiment, the stroke determining unit 47 calculates the amount of the relative stroke of the driving unit 20 on the basis of the result of detection obtained by the stroke sensor 94, and determines whether the calculated relative stroke exceeds an upper threshold of the stroke or not or falls below the upper threshold of the stroke or not. In particular, in the present embodiment, the determination about the upper threshold of the stroke is made by determining whether the amount of the relative stroke is excessively greater than the target amount of depression set by the depression amount setting unit 41 or not (specifically, whether a value obtained by subtracting the target amount of depression from the amount of the relative stroke exceeds a certain threshold or not). If the amount of the relative stroke is excessively greater, it is determined that the holding power of a rescuer is low, or a condition of application of the low holding power has been accumulated. Thus, in order to prevent the relative stroke from reaching the mechanical upper limit of the driving unit 40, the notification controller 45 makes the indicator “low” at the holding power notifying part 52 light up to urge the rescuer to increase the holding power. As a result, the amount of the relative stroke is made closer to the target amount of depression.

Conversely, a determination about a lower threshold of a stroke is made by determining whether the amount of the relative stroke is excessively smaller than the target amount of depression set by the depression amount setting unit 41 or not (specifically, whether a value obtained by subtracting the amount of the relative stroke from the target amount of depression exceeds a certain threshold or not). If the amount of the relative stroke is excessively smaller, it is determined that the holding power of the rescuer is high, or a condition of application of the high holding power has been accumulated. In this case, the notification controller 45 makes the indicator “high” at the holding power notifying part 52 light up to urge the rescuer to reduce the holding power. As a result, the amount of the relative stroke is made closer to the target amount of depression. In this way, not only the “depth” of depression of a sternum but also the “distance” of the depression can be controlled appropriately. This acts advantageously for the reason that, regarding chest compression, not only a depression depth but also recoil (depression distance) is an important issue.

Here, the determinations about the upper and lower thresholds of a stroke are made by using the amount of depression. Meanwhile, the mechanical upper and lower limits of the relative stroke of the driving unit 20 are applicable. Or, values close to these limits may be set uniquely.

The operation starting and stopping controller 48 controls start and stop of the stroke operation by the driving unit 20. More specifically, the operation starting and stopping controller 48 determines whether an external force is applied to the pressure member 10 or not. If determining that an external force is applied, the operation starting and stopping controller 48 instructs the stroke controller 42 to start actual pressing operation. Further, at the start of the operation, the operation starting and stopping controller 48 controls the driving unit 20 not to achieve the target amount of depression from the beginning, but controls the driving unit 20 such that the amount of the relative stroke is increased gradually to reach the target amount of depression after several pressing operations.

In this way, chest compression can be started in response to the act of pressing the pressure member 10 against a patient's chest as a start switch, without separately performing an operation with a start switch and the like. Thus, while the automatic chest compression device 1 is held firmly with both hands, compression can be started in a stable condition. If the stroke is increased at a dash at the start of the operation, an inexperienced rescuer may be surprised at the strength of the resultant reaction force or the magnitude of target stroke. Thus, the rescuer may suspend chest compression. However, if the stroke is increased gradually as in the present embodiment, the rescuer can achieve the target amount of depression in a stable condition by increasing the holding power gradually. It is preferable that a control be exerted such that the target amount of depression is achieved before compression is applied ten times or less, and more desirably, five times or less.

If determining that no external force is applied to the pressure member 10, the operation starting and stopping controller 48 automatically stops depression by the pressure member 10 with the target amount of depression.

Various techniques are applicable in determining whether an external force is applied to the pressure member 10 or not. For example, a pressure-sensitive element is buried in the pressure surface 10A of the pressure member 10, and a signal from the pressure-sensitive element can be used in determination about an external force. As another favorable example, the driving unit 20 oscillates the pressure member 10 in an unloaded condition with a preparatory minute stroke, and the presence or absence of the external force is determined on the basis of whether a feedback control signal has been entered (value of a driving current has been changed) in response to the action of the external force or not.

If a desirable relative stroke cannot be output due to failure of the driving unit 20, or if a relative stroke has reached the mechanical upper or lower limit, for example, the error display part 46 makes the notification controller 45 display an error for a rescuer. In the present embodiment, an error number is displayed in the form of digital representation on the depression amount notifying part 56. For example, if the relative stroke has reached the upper or lower limit, the automatic chest compression device 1 is separated from a patient, and measurement of the amount of movement by each sensor is resent once. Then, the automatic chest compression device 1 is restarted. In this way, accumulation of measurement errors can be resolved at regular intervals.

Use of the automatic chest compression device 1 will now be described. A case where cardiopulmonary resuscitation by chest compression is applied to an immature baby in the embodiment will be introduced.

The automatic chest compression device 1 is powered on, and the height and the thickness of the chest of the immature baby are measured visually. Then, a rescuer sets the target amount of depression (2 cm, for example). This setting is made by rotating a dial of the stroke adjuster 40A.

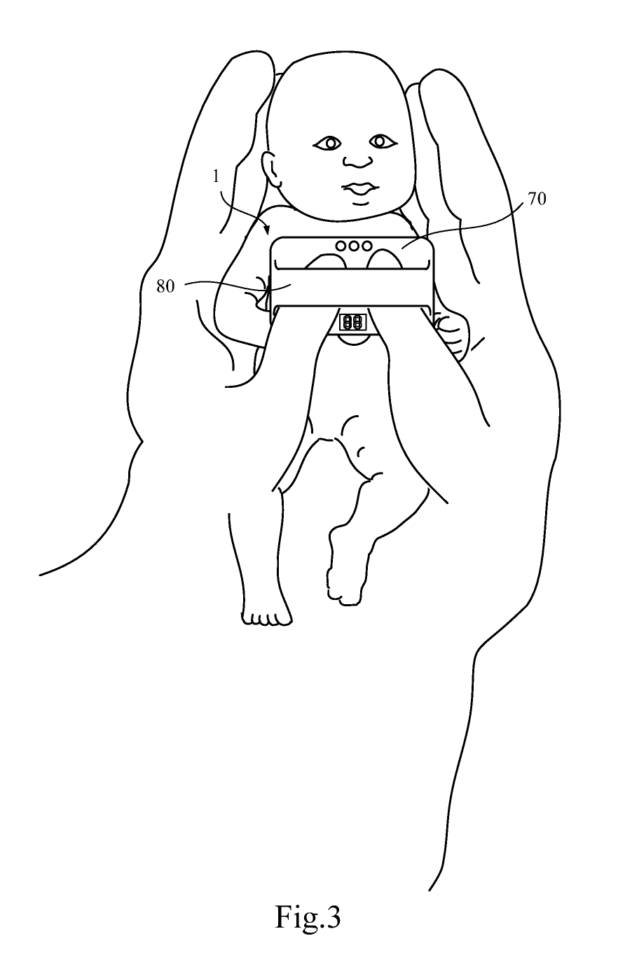

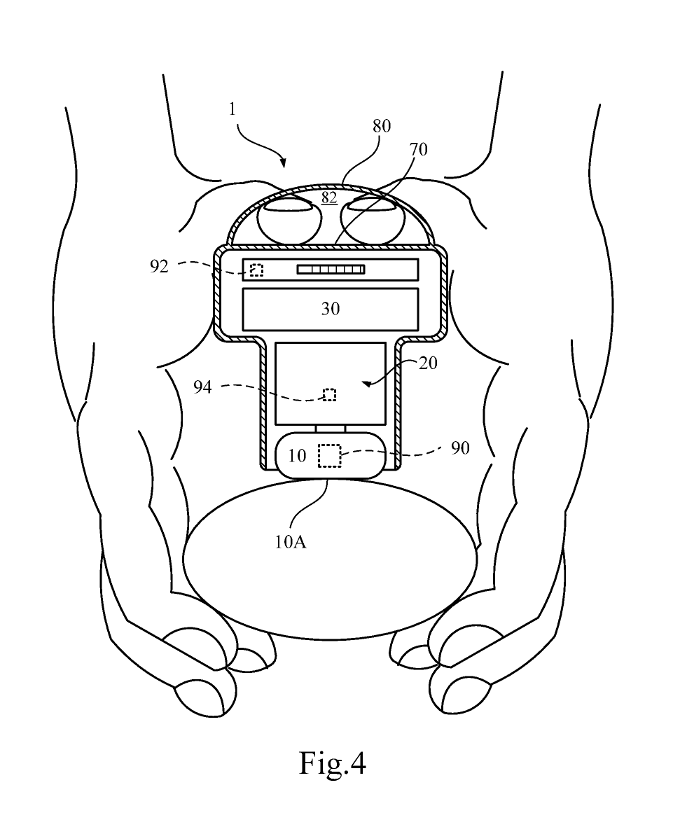

Next, as shown in FIGS. 3 and 4, the rescuer inserts the thumbs of both hands into the insertion space 82 of the automatic chest compression device 1 to hold the automatic chest compression device 1 with the thumbs of both hands. In this condition, while holding the immature baby in the entire palms of the hands, the rescuer applies the pressure surface 10A of the pressure member 10 to a chest. When the pressure member 10 is pressed against the chest, the operation starting and stopping controller 48 detects this press, and increases the relative stroke of the driving unit 20 gradually. The target amount of depression is achieved with compression applied several times. The control unit 40 uses the pressurizing-side moving sensor 90 to provide control such that the pressure member 10 always presses a sternum to a depth of 2 cm. Meanwhile, a reaction force transferred to the thumbs increases during the pressing process to make the thumbs retract upward. The upward retraction of the thumbs reduces the amount of movement of the pressure member 10 (substantial amount of depression) detected by the pressurizing-side moving sensor 90. This reduction is detected by the stroke controller 42 to automatically increase the relative stroke. Thus, even if the thumbs retract upward, the substantial amount of depression is automatically maintained at 2 cm. More specifically, even if the holding power with the thumbs is lowered gradually after the operation of chest compression for several minutes, the driving unit 20 increases the relative stroke to compensate for the lowered power. Thus, the substantial amount of depression can always be maintained at 2 cm without involving setting change and the like of the device itself.

Conversely, if the rescuer applies too much force, the stroke controller 42 automatically reduces the relative stroke of the driving unit 20. This makes it possible to automatically prevent increase of the substantial amount of depression of the chest to an excessive degree.

In parallel with the control of the substantial amount of depression by the pressure member 10, the retraction amount calculating part 44 calculates the substantial amount of retraction of the pressure receiving unit 70 (thumbs). Then, the retraction amount calculating part 44 urges the rescuer by using the holding power notifying part 52 provided to the pressure receiving unit 70 to apply optimum holding power. While checking instructive information on the holding power notifying part 52, the rescuer is allowed to apply optimum holding power only by controlling the power of the thumbs. As a result, not only the depth of depression by the pressure member 10 but also a moving distance can be maintained appropriately. Further, the amount of retraction of the pressure receiving unit 70 is reduced, so that the automatic chest compression device 1 can be held in a stable condition.

An error of the control of the amount of movement of the pressure member 10 and an error of the control of the amount of retraction of the pressure receiving unit 70 may be accumulated during performing of these controls. In this case, a distance of depression by the pressure member 10 may be too small even if the press by the pressure member 10 achieves a satisfactory “depth.” Conversely, a distance of depression may be too large to the extent that the pressure member 10 is suspended above the chest. Thus, the stroke determining unit 47 controls the relative stroke by the driving unit 20. More specifically, the stroke determining unit 47 determines how far the amount of the relative stroke by the driving unit 20 and a substantial distance of depression by the pressure member 10 (this may be the target amount of depression) differ from each other. Then, the stroke determining unit 47 urges the rescuer to adjust the holding power so as to minimize the difference. As a result, the amount of the relative stroke by the driving unit 20 is also optimized automatically. This makes it possible to avoid a situation where the driving unit 20 reaches the limit of a stroke to become uncontrollable, for example.

As described above, the automatic chest compression device 1 realizes chest compression reliably without involving any complicate operation by a rescuer. The number of times a chest is actually compressed may be changed appropriately according to the condition of a patient, for example. For example, the chest is compressed 30 times and then artificial respiration is given twice, and this operation is repeated. At this time, it is preferable that time of suspension of the chest compression do not exceed 10 seconds by giving artificial respiration quickly. The chest compression encourages heart resuscitation and allows lungs to be operated forcedly. Even in this case, depressing operation is stopped automatically by using the thumbs of both hands to suspend the automatic chest compression device 1 above a body. When the depressing operation is stopped, the respiratory condition of an immature baby can be checked, or artificial respiration can be given.

In the aforementioned embodiment, the amount of the relative stroke of the driving unit 20 is detected directly by the stroke sensor 94, to which the invention is not intended to be limited. For example, the amount of the relative stroke may also be detected indirectly by using a current value of the driving unit 20, for example. By using both the pressurizing-side moving sensor 90 and the pressure receiving-side moving sensor 92, a difference in the amount of movement between these sensors may be determined, and the amount of the relative stroke of the driving unit 20 may indirectly be calculated on the basis of the difference.

In the aforementioned embodiment, both the pressurizing-side moving sensor 90 and the pressure receiving-side moving sensor 92 are provided, to which the invention is not intended to be limited. For example, if a relative stroke by the driving unit 20 is detected (by using the stroke sensor 94, for example) and the amount of movement (amount of retraction) of the pressure receiving unit 70 is detected by the pressure receiving-side moving sensor 92, an actual amount of depression by the pressure member 10 can be calculated on the basis of a difference between the amounts thereby detected. Likewise, if a relative stroke by the driving unit 20 is detected (by using the stroke sensor 94, for example) and the amount of movement of the pressure member 10 (substantial amount of depression) is detected by the pressurizing-side moving sensor 90, the actual amount of the retraction of the pressure receiving unit 70 can be calculated on the basis of a difference between the amounts thereby detected.

Additionally, in the aforementioned embodiment, the automatic chest compression device 1 is intended to be used for immature babies, for example. Meanwhile, if the automatic chest compression device 1 is intended to be used for persons including infants, children and adults except immature babies, a rescuer cannot withstand the reaction force only with thumbs. Thus, if an automatic chest compression device is intended to be used for adults, for example, it is preferable that the automatic chest compression device have structures as follows. A lever to be gripped with hands is provided, so that a rescuer is allowed to withstand the reaction force by gripping the lever with both hands. Or, a pressure receiving unit of a wider area is prepared, so that the rescuer is allowed to withstand the reaction force by holding the pressure receiving unit under the force of the palms of hands.

Further, in the present embodiment, the rechargeable battery 30 is shown as a power supply, to which the invention is not intended to be limited. For example, a dry battery may be used, or electricity may be supplied from an external power supply through a wire.

Still further, in the aforementioned embodiment, the notifying unit 50 transmits various information to a rescuer through the indicators, to which the invention is not intended to be limited. It is also preferable that the rescuer be notified of the information through voices. A viewpoint is often concentrated on checking the situation of a patient during operation, so that transmission of information through voices provides easier determination to the rescuer.

The chest compression described here is targeted for humans. As a matter of course, the chest compression is also applicable to animals such as dogs and cats except humans.

The automatic chest compression device of the present invention is not limited to the aforementioned embodiment, but various changes can certainly be devised without departing from the spirit of the present invention.

### INDUSTRIAL APPLICABILITY

The present invention is applicable for various purposes of chest compression irrespective of location, age, and animal type.

1. An automatic chest compression device, comprising:
a pressure member that makes abutting contact with a chest of a body;
a driving unit that makes the pressure member move to and fro;
a pressure receiving unit that allows rescuer's hands to receive a reaction force which is generated on the side of the driving unit when the chest of the body is compressed by the pressure member; and
a control unit that calculates a substantial amount of depression of the chest by the pressure member, and controls a stroke of the pressure member given by the driving unit.

2. The automatic chest compression device according to claim 1, wherein the pressure receiving unit includes a restraining unit provided to fix fingers of hands of a rescuer.

3. The automatic chest compression device according to claim 2, wherein the restricting unit fixes thumbs of the hands.

4. The automatic chest compression device according to claim 1, comprising a pressurizing-side moving sensor arranged on the side of the pressure member, the pressurizing-side moving sensor measuring a condition of movement of the pressure member.

5. The automatic chest compression device according to claim 1, comprising a pressure receiving-side moving sensor arranged on the side of the pressure receiving unit, the pressure receiving-side moving sensor measuring a condition of movement of the pressure receiving unit.

6. The automatic chest compression device according to claim 1, comprising a stroke determining unit that determines a relative stroke between the pressure member and the driving unit.

7. The automatic chest compression device according to claim 1, wherein the control unit increases the relative stroke of the pressure member given by the driving unit if the substantial amount of depression by the pressure member falls below a lower threshold.

8. The automatic chest compression device according to claim 1, wherein the control unit reduces the relative stroke of the pressure member given by the driving unit if the substantial amount of depression by the pressure member exceeds an upper threshold.

9. The automatic chest compression device according to claim 1, wherein the control unit includes a notifying unit that informs the rescuer of shortage or excess of holding power.

10. The automatic chest compression device according to claim 9, wherein the notifying unit notifies the rescuer of shortage of the holding power if the substantial amount of depression by the pressure member is insufficient.

11. The automatic chest compression device according to claim 9, wherein the notifying unit notifies the rescuer of excess of the holding power if the substantial amount of depression by the pressure member is excessive.

12. The automatic chest compression device according to claim 9, wherein the notifying unit notifies the rescuer of shortage of the holding power if the relative stroke between the pressure member and the driving unit is greater than an upper threshold of the stroke.

13. The automatic chest compression device according to claim 9, wherein the notifying unit notifies the rescuer of excess of the holding power if the relative stroke between the pressure member and the driving unit is smaller than a lower threshold of the stroke.

14. The automatic chest compression device according to claim 9, wherein the control unit includes a depression amount setting unit that sets a target value of the substantial amount of depression by the pressure member.

15. The automatic chest compression device according to claim 1, wherein the control unit includes an operation starting and stopping controller that controls start and stop of depressing operation by the pressure member on the basis of whether an external force is applied to the pressure member or not.
